(19) United States
(12) Patent Application Publication
(10) Pub. No.: US 2026/0098635 A1
(43) Pub. Date: Apr. 9, 2026

(54) SMART AGRICULTURE BIOCHAR PRODUCTION YIELD PREDICTION AND MEASUREMENT

(71) Applicant: Applied Carbon, Inc., Houston, TX (US)

(72) Inventors: Larry Charles Dodson, Dripping Springs, TX (US); Przemyslaw Zawadzki, Houston, TX (US); Nathaniel Fino, Nacogdoches, TX (US); Daniel Wright Mulqueen, Charleston, SC (US); Jason Lee Aramburu, Houston, TX (US); Morgan Michael Williams, Loma, CO (US)

(21) Appl. No.: 19/350,924

(22) Filed: Oct. 6, 2025

Related U.S. Application Data
(60) Provisional application No. 63/703,284, filed on Oct. 4, 2024.

(51) Int. Cl. F23G 5/027; F23G 5/40; G05D 1/246; G05D 1/646; G05D 105/00; G05D 107/20; G05D 109/10; G06V 10/58; G06V 20/10; G06V 20/13; G06V 20/17

(52) U.S. Cl. CPC F23G 5/027; F23G 5/40; G05D 1/246; G05D 1/646; G06V 10/58; G06V 20/13; G06V 20/17; G06V 20/188; F23G 2207/101; F23G 2209/262; G05D 2105/14; G05D 2107/21; G05D 2109/10

(57) ABSTRACT

The present invention relates to a system for smart agriculture biochar production, yield prediction, and measurement. The system utilizes real time remote sensing of the local environment, weather and related conditions, and data analysis on spatial and spectral imagery data captured from satellite sensors, aerial sensors, and agricultural drones. The system performs a field mapping of a target field having a biomass and obtaining spectral imagery data of the biomass. A mobile pyrolysis system is deployed about the target field and follows a path derived from the spectral imagery data.

### CROSS-REFERENCE TO RELATED APPLICATIONS

This application claims the benefit of priority to U.S. Provisional Application No. 63/703,284, filed on Oct. 4, 2024, which is hereby incorporated by reference in its entirety.

### FIELD

The present invention relates generally to the field of smart agriculture and agricultural waste management, and more particularly to systems and methods for smart agriculture biochar production yield prediction and measurement.

### SUMMARY

The present invention relates to a system for smart agriculture biochar production, yield prediction, and measurement. The system utilizes real time remote sensing of the local environment, weather and related conditions, and data analysis on spatial and spectral imagery data captured from satellite sensors, aerial sensors, and agricultural drones. The system performs a field mapping of a target field having a biomass and obtaining spectral imagery data of the biomass. A mobile pyrolysis system is deployed about the target field and follows a path derived from the spectral imagery data.

In some embodiments, a system and methods for smart agriculture biochar production, yield prediction, and measurement is described. The system utilizes real time remote sensing of the local environment, weather and related conditions, and data analysis on spatial and spectral imagery data captured from satellite sensors, aerial sensors, and agricultural drones.

The system utilizes machine learning methods and processes to perform big-data analysis on the combined data inputs to deliver a package of solutions that include visualizations and insights reports for use in business planning and decision support with focus on operational efficiency, farm sustainability, sales contract fulfillment, financial reporting, and workforce scheduling.

The system also provides an approach to know and predict the status of growth and to predict the time of harvest for specific crops based on geo locations. The infield biomass of interest for the invention is post-harvest residue material rather than crop biomass. The system can predict volumes of waste biomass from pre-harvest material. The invention utilizes spectral data from satellite, aerial, and drone imaging, data analysis with visualizations and insights, and action items, reports, business planning, operations costs, and corporate planning.

The appended claims may serve as a summary of this application.

### BRIEF DESCRIPTION OF THE DRAWINGS

FIG. 1 is a diagram illustrating a process according to some embodiments.

FIG. 2 is a diagram illustrating a process according to some embodiments.

FIG. 3 is a diagram illustrating a process according to some embodiments.

FIG. 4 is a diagram illustrating a process according to some embodiments.

FIG. 5 is a table illustrating smart agriculture products and services.

FIG. 6 is a diagram illustrating drone platform components.

FIG. 7 is a diagram illustrating a process according to some embodiments.

FIG. 8 is a flow chart illustrating an exemplary method that may be performed in some embodiments.

FIG. 9 is an embodiment of a mobile pyrolysis system comprising: a forage harvester, tractor and pyrolysis and oxidizer apparatus

FIGS. 10A-10B is a diagram illustrating an exemplary reactor and operation process of the mobile pyrolysis system of FIG. 9.

FIG. 11 is a diagram illustrating an exemplary computer that may perform processing in some embodiments.

### DETAILED DESCRIPTION OF THE DRAWINGS

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and their equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

The present invention relates to a method for smart agriculture biochar production for yield prediction, measure, and optimization. The invention provides a logical system of processes that combines real time remote sensing through satellite and drone spectral imagery data to inform the operation of an in-field biomass pyrolysis system for the production of biochar. The infield biomass of interest for the invention is post-harvest residue material rather than crop biomass. The remote data is captured on location in tandem with air, soil temperatures and relative humidity. The system uses NIR (Near Infrared), multispectral and hyperspectral imaging, with vegetation indices, machine learning solutions and insight services, to determine the stages of crop growth and maturation, to accurately predict the time of agricultural waste harvesting for specific crops and the volume and mass of waste to be used as feedstock biomass.

The inventive system combines satellite (high breadth, low depth) with drone (low breadth, high depth) multi-spectral and hyperspectral data to generate vegetation indices that are used to predict field characteristics. These field characteristics (such as yield potential, plant vigor, and chlorophyll content) can be tied together with known material characteristics such as biomass-to-biochar conversion ratio, biomass moisture continent and field area to create an analytical operations solution. This analytical solution delivered by the invention combines the data and analysis of the in-field biomass with the in-field pyrolysis system to determine the optimal pyrolysis process parameters to enhance biochar production, and predict biochar production yields from biomass to biochar. The invention also provides a system of analysis for the sales team and marketing campaigns, through historical data analysis of customer farms to identify when, where and how the biochar will be applied and a history of biochar effects on their land. The invention also provides a system of analysis for monitoring, reporting, and verification (MRV) of total biomass processed and biochar produced for carbon offset quantification. The invention consists of a Master Process (MA) which consists of three key processes; the Scheduling and Dispatch Process (SDA), the Field Processing Process (FPA), the Drone Analysis Process (DAA).

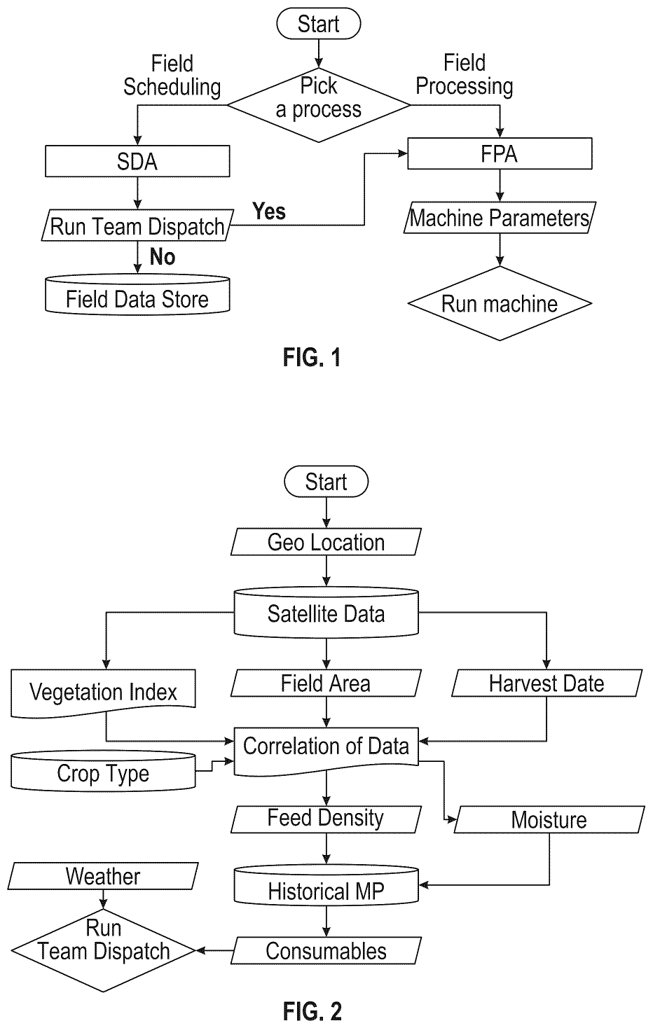

FIG. 1 is a diagram illustrating a process according to some embodiments. The Master Process (MA) consists of a decision tree utilizing the SDA, and FPA with the FPA utilizing the DAA. The operator selects a process, either Field Scheduling or Field Processing. Depending on the decision to go SDA or straight to FPA, this process auto generates the necessary information for optimized deployment and operation in the field. If Field Scheduling is selected, the MA will run the SDA, which will determine the optimal time to deploy a system and team for field processing. The Run Team Dispatch will deploy a team, consisting of a mobile pyrolysis system, operations team, and support equipment, to a farm site, at which point the FPA will begin. If a Run Team is not dispatched, the field data from the SDA will be stored to grow and optimize the SDA database. If Field Processing is selected, the FPA will begin directly. The FPA will be utilized to determine machine parameters prior to the mobile pyrolysis system being in operation, by correlating the crop type with historical machine parameters. The MA will be stopped by operators when field operations are complete.

The mobile pyrolysis system has a wide range of parameters which may be influenced by the MA. For example, if the FPA detects an increasing density of biomass in the path of the pyrolysis system, the MA may instruct the pyrolysis system to slow its speed—and by association, its feed rate—in order to maintain a consistent feed rate into the system. If the FPA detects a lower density of biomass, the opposite action would be taken. In another example, if the FPA detects an increasing moisture content of biomass in the path of the pyrolysis system, the MA may instruct the pyrolysis system to proactively increase the heat in the drying, preheating, or pyrolysis stages of processing in order to provide the necessary energy when higher moisture feedstock enters the system. Another example would be when the FPA detects a change to feedstock properties, the MA may adjust the machine parameters from one predetermined condition to another, with the change occurring simultaneously with the change in input biomass. Another example would be the correlation of field data from the FPA with machine data from the pyrolysis system to build and train machine learning methods for future operations.

FIG. 2 is a diagram illustrating a process according to some embodiments. The Scheduling and Dispatch Process is the first wave of analysis used to predict and plan the dispatch of the pyrolyzer and prime mover based on current and historical information of the target farm. The SDA is initiated by the MA when Field Scheduling is selected, but can be initiated manually. A geographic location is selected manually, which is used by the SDA to select data from a database including satellite imagery, drone imagery, and manually collected crop and field data. This data is processed into Vegetation Indices through multispectral correlation equations that are commonly used in industry. These Vegetation Indices give information about the volume, mass, moisture, and condition of biomass material on the field. Vegetation Indices are tied together with the Field Area, projected Harvest Date, and prebuilt crop type data sets in the Correlation of Data to produce the Feed Density and Moisture needed for setting machine parameters. The Correlation of Data predicts what consumables will be used in Field Processing, based off of Feed Density and Moisture of the crop in the field. The Consumables information, tied together with historical and predicted Weather conditions, generates the optimal series of dates for field operation and run team dispatch.

Vegetation Indices are created using a combination of equations including the Normalized Difference Vegetation Index (NDVI):

$$NDVI = ( NIR - RED ) / ( NIR + RED )$$

Other factors are calculated using the formula Enhanced Vegetation Index (EVI), Soil-Adjusted Vegetation Index (SAVI), and Red Edge Normalized Difference Vegetation Index (NDRE). EVI is more sensitive in areas with dense vegetation and corrects for some atmospheric conditions and background noise. SAVI is used to correct NDVI and EVI for brightness of visible soil in areas where vegetative cover is low. NDRE is similar to NDVI, however the red-edge band is sensitive to medium to high levels of chlorophyll content. NDRE is also capable of penetrating further into the leaf canopy due to its 715 nm range than the red band.

$$NDRE = ( NIR - RE ) / ( NIR + RE )$$

Data can be correlated through a number of means, one example workflow follows. First, Data is collected which includes; spectral imagery data, measured soil data, historical operational data, and weather and satellite data. Second, data is geospatially aligned so that each data point corresponds to the exact location where yield data was collected. Third, statistical methods are used to correlate the data and quantify the relationship between spectral data and biomass properties. These include linear regression, Pearson correlation, and machine learning models such as artificial neural networks. Finally, results are analyzed and validated by direct measurement.

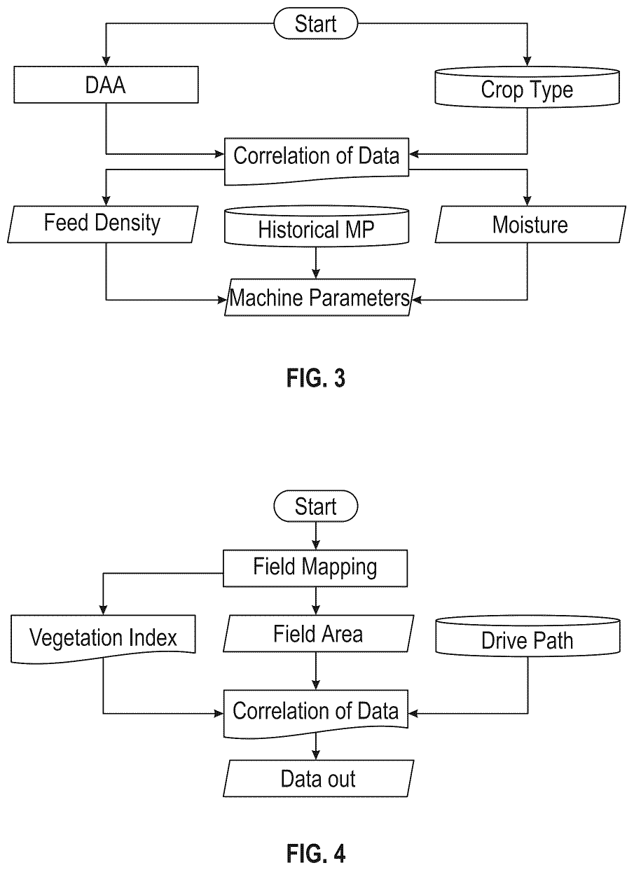

FIG. 3 is a diagram illustrating a process according to some embodiments. The Field Processing Process uses the DAA, along with collected crop type data, to define Machine Parameters for a mobile pyrolysis system based on the Feed Density and Moisture. The FPA is initiated by the MA when Field Processing is selected but can be initiated manually. On initiation, the FPA, begins the DAA which will output a map of biomass (ranging from 1 to −1, green to red, based on the vegetation indices) in the target field. The output of the DAA and Crop Type data are used to generate the Correlation of Data file. The Correlation of Data file outputs maps (as described above) of Feed Density and Moisture based on the input data from the DAA and the Crop Type, which are used in conjunction with Historical Machine Parameters to generate new optimized machine parameters (being auger speeds, temperature settings and water usage) for the current field. Operational data from the pyrolysis system will be added to Historical Machine Parameters data set for future runs as a training set for a neural network.

Example field conditions which would be measured by the invention include: Pre-harvest fields with standing biomass which is high in moisture and has not been cut which provides a high degree of soil cover, freshly harvested fields with windrowed crops with high moisture and more exposed soil, fields with dried biomass, with lower moisture and variable soil cover, and failed crops with highly varied moisture content, biomass density, and soil cover.

Data can be correlated through a number of means, one example workflow follows. First, data is collected which includes; spectral imagery data, measured soil data, historical operational data, and weather and satellite data. Second, data is geospatially aligned so that each data point corresponds to the exact location where yield data was collected. Third, statistical methods are used to correlate the data and quantify the relationship between spectral data and biomass properties. These include linear regression, Pearson correlation, and machine learning models such as artificial neural networks. Finally, results are analyzed and validated by direct measurement.

New optimized machine parameters are generated through multiple steps. First, expected output values including product char properties, fuel usage, and reactor temperatures are compared to actual measured values. Second, differences in measured outputs from projected outputs are processed using linear algebra to create an array of correction values to adjust future machine operation. Third, process data and field data is added to a training data set for an automated neural network which determines pyrolysis system machine parameters.

FIG. 4 is a diagram illustrating a process according to some embodiments. The Drone Analysis Process takes the multispectral drone dataset and converts it into vegetation indices (ranging from 1 to −1, green to red, based on the vegetation indices) to identify crop health, moisture content and other metrics based on the spectral intensity captured by the imagers. The DAA is initiated by the FPA on initiation, but can be initiated manually. In the DAA, a drone with imaging equipment conducts Field Mapping, in which the subject field is mapped. The spectral data from Field Mapping is used to identify biomass feedstock information from a Vegetation Index. The Field Area is also plotted. The Pyrolysis System Drive Path is inputted manually using GPS tracking software on the raking attachment in the field. The Vegetation Index, Field Area, and Pyrolysis System Drive Path are correlated to produce a data set that is interpreted by the GUI in the tractor of expected feedstock conditions which can be utilized by the FPA.

All data is correlated via adjacent historical or predefined data sets to interpret the live data for machine parameter prediction. Data can be correlated through a number of means, one example workflow follows. First, Data is collected which includes; spectral imagery data, measured soil data, historical operational data, and weather and satellite data. Second, data is geospatially aligned so that each data point corresponds to the exact location where yield data was collected. Third, data for fields is projected along the Pyrolysis System Drive Path to provide a linear map of field biomass. Fourth, statistical methods are used to correlate the data and quantify the relationship between spectral data and biomass properties. These include linear regression, Pearson correlation, and machine learning models such as artificial neural networks. Finally, results are analyzed and validated by direct measurement.

Field data, which is projected along the Pyrolysis System Drive Path, will be processed with a database of process setpoints for varying conditions in order to produce a spatial map of reactor conditions and—when adjusted for projected reactor speed—will schedule reactor conditions. This projection included targets for refueling and resupply of consumables such as water. As the pyrolysis system operates, GPS data is used to reference the predicted location as well as anticipated changes to incoming feedstock. These changes allow for proactive changes to multiple controls such as reactor temperature, system speed, process residence time, and gas removal rates to ensure that there is minimal variation in the properties of output char.

In-field crop drying times are predicted by comparing the moisture of crops—as measured by spectral imagery—with projected weather data for the area including temperature, humidity, wind, and precipitation. This data can be correlated with a database of known crop drying times using statistical interpolation to project the time required for biomass in a field to reach a target moisture level.

The heat map used in the DAA is built using the multispectral drone platform as it performs its field mapping process. After the data is collected from field mapping, it is analyzed to build out the vegetation indices mentioned above. Based on the datasets of each multispectral band, and the associated equations used to convert the spectral bands into vegetation indices, the data can be placed in arrays to inform the machine of incoming field characteristics. These characteristics such as moisture content, approximate yield, chlorophyll content and density are displayed as a heat map ranging from ranging from 1 to −1, green to red, based on the vegetation indices to graphically represent the range of each field characteristic to the operator.

One example of the described production optimization is related to adjusting process conditions for varying moisture. As a mobile pyrolysis system is processing a field, the system described herein can measure and map the moisture of biomass to be processed. This map will be used to adjust reactor conditions such as reactor temperatures and auger RPMs to proactively deal with increasing and decreasing moisture content by adding or removing, respectively, heat and residence time from drying and preheating stages of the pyrolysis process to maintain consistent char properties and yield in the final product. Similarly, the system can be used to map and predict crop drying times with forecasted weather conditions and set waiting periods of selected fields to process based on approximate moisture content and to develop paths to minimize energy required for drying.

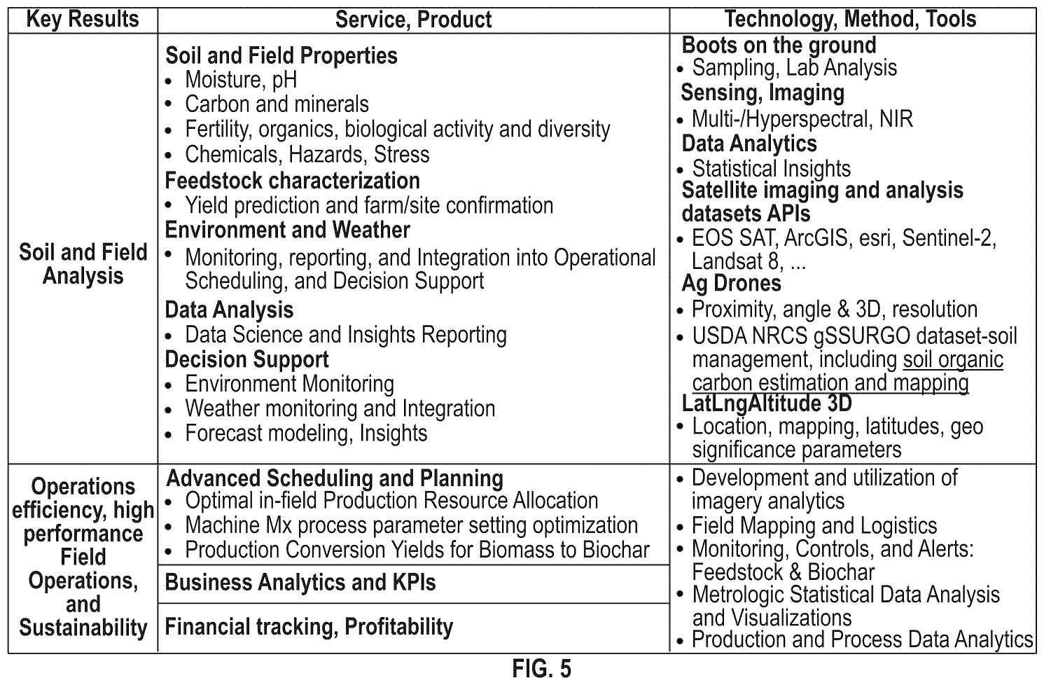

Another example of the described production optimization is related to changing feedstock conditions. As a mobile pyrolysis system is processing a field, the system described herein can measure and map the density of biomass to be processed. This map will be used to adjust reactor conditions to proactively deal with increasing and decreasing density by adding or removing, respectively, heat and residence time from the pyrolysis process to maintain consistent char properties and yield in the final product. FIG. 5 provides an overview of the key results from the invention, the services and products provided to the customer through the invention and the technology, methods and tools used to drive the invention to work. FIG. 5 is a table illustrating smart agriculture products and services.

The use of remote sensing unlocks the ability to collect and analyze environmental parameters such as estimated crop yield, crop density, moisture content, terrain mapping and other factors that have before been unreachable. Traditionally, data is collected through satellites and drones, and then analyzed to create vegetation indexes used to identify desirable environmental characteristics. The described system utilizes these three key systems (satellite data, drone data and vegetation indices) in one integrated and automated process to optimize in-field efficiency, accuracy and useability of the in-field pyrolysis system.

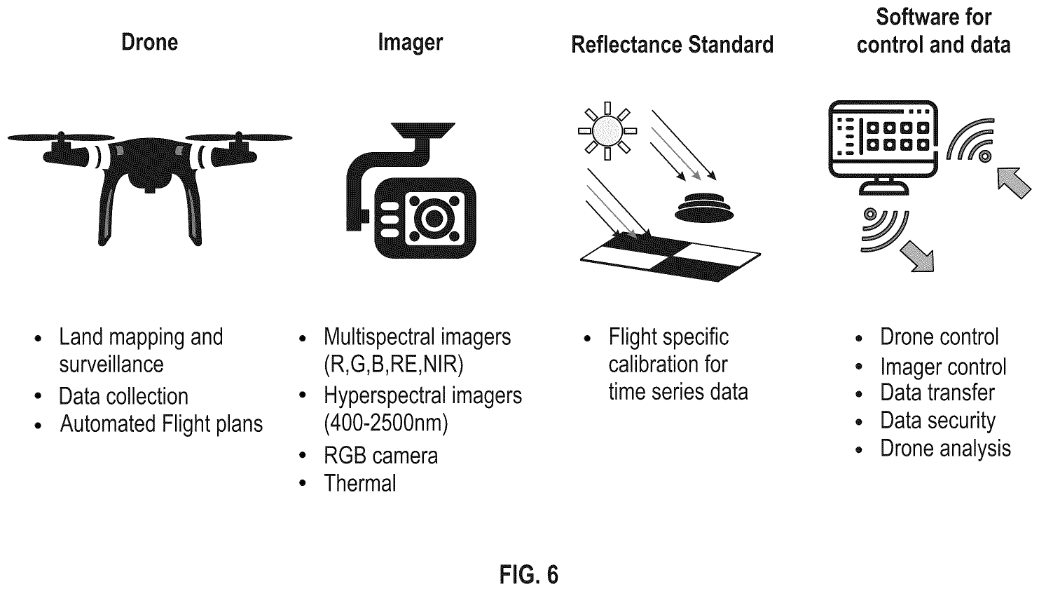

FIG. 6 is a diagram illustrating drone platform components. The drone platform comprises four main systems used on the drone platform to collect data for analysis. The described system also generates a “heat-map” through vegetation indices that can be used to determine and implement the transit path of the in-field pyrolysis system (example a tractor and harvester with a mobile pyrolysis system) within the Field, predict the time duration of the field operation based on field conditions of available biomass (density, moisture, land topography), and reference terms of the field operations to determine operational costs (including consumption of consumables), and amount of char produced. Utilizing collected data from the field and pyrolysis equipment, the system described can link to data on the chemical analysis of the biomass, and produced biochar.

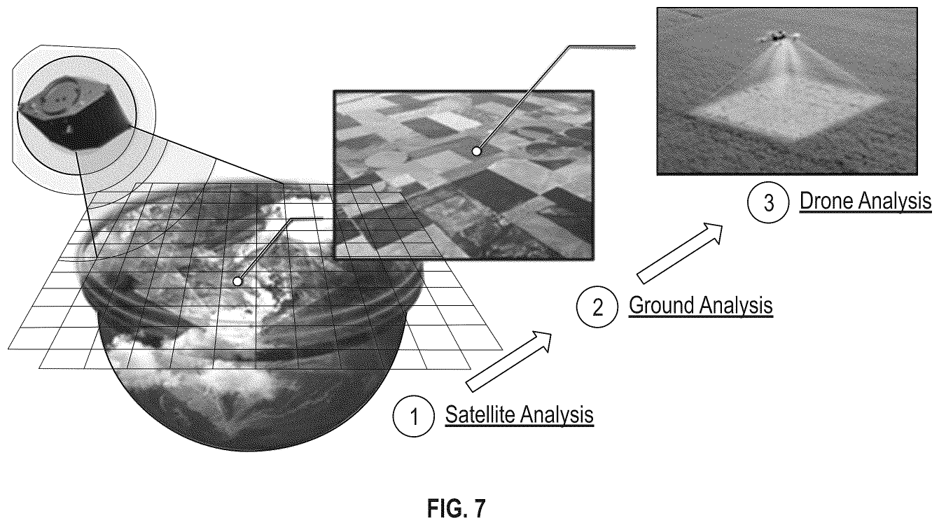

The proposed method of field selection follows a three-level decision making process as shown in FIG. 7.

Satellite imagery, to locate and identify the target field for historical crop analysis, to generate metrics for customer quotations and estimated yield conversions.

Ground analysis, to further sample and learn field characteristics, expected yield, land topography and drive trajectories with land based hyper and multispectral images.

Drone mapping, to generate a stitched digital twin of the field to predict field characteristics in a holistic and complete view. The digital twin is used to generate expected char conversion, drive trajectories, pre and post char application data, expected consumable usage and land topography for machine parameter setting.

Ultimate and proximate analysis of field biomass (conducted prior to biochar conversion) and the on-board automated NIR crop analysis, will be correlated and linked to data available via API with available imaging using targeted spectral bands, to perform predictive analysis, to generate business and operational insights. Utilizing machine learning neural network tools and the before mentioned AC processes to optimize pyrolyzer machine setting will help to increase statistical confidence in the ability to produce qualified, consistent biochar (H to C ratio of 0.4 for below), and predict optimal days to perform in-field pyrolysis, based on geo location and latitude, field moisture, biomass moisture, ambient temperature.

Another application of multiscale, multispectral imaging is in the quantification and tracking of the carbon intensity of biochar production and biochar application to fields as a carbon sequestration medium and soil additive. The described tools may be used to track the deployment of biochar to fields for reporting to customers and certification bodies.

While the system described herein is focused on an in-field, on the fly conversion system, the same principles and methods could be applied to tracking biomass feedstock properties for collection for an edge of field system or for collection of residue materials for transportation to a centralized facility. The invention has applications for residue collection and utilization outside of pyrolytic processing, for upcycling of wastes including fiber production, fuel utilization, and other waste recovery uses.

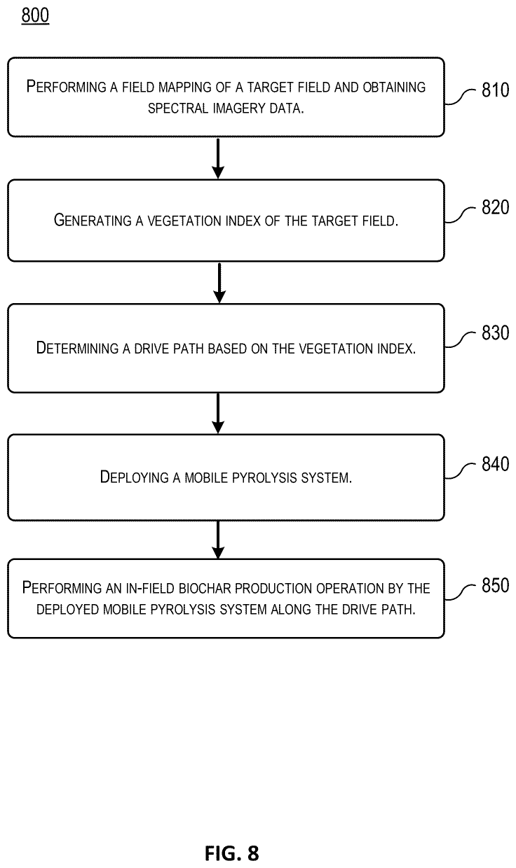

FIG. 8 is a flow chart illustrating an exemplary method 800 that may be performed in some embodiments. In some embodiments, a mobile pyrolysis system is deployed about a target field and follows a generated drive path based on the obtained spectral image and other field data associated with the target field.

In step 810, the system performs a field mapping of a target field and obtains spectral imagery data. For example, the system performs a field mapping of a target field having a biomass and obtaining spectral imagery data of the biomass using one or more drones.

In some embodiments, the system converts a multispectral image data set of images obtained by one or more drones into the vegetation index, wherein the vegetation index identifies crop health data, field density data and/or moisture content data of the target field.

In some embodiments, the spectral imagery data is captured from satellite sensors, aerial sensors, and agricultural drones that obtain sensor data of the target field area.

In some embodiments, the system collects one more of data comprising spectral imagery data, measured soil data, historical operational data, and weather and satellite data.

In some embodiments, the system geospatially aligns data points of collected data to correspond to geo-spatial locations of where yield data of the biomass was collected about the target field.

In step 820, the system uses the obtain the spectral imagery data to identify biomass feedstock to generate a vegetation index.

In step 830, the system determines a drive path based on the vegetation index. The drive path series of geo-spatial locations that form a path about the target field. The path is a route that the mobile pyrolysis system is to follow to produce biochar from a feedstock in the target field.

In some embodiments, the system generates a stitched digital twin image or mapping of the target field based on multiple images obtained by one or more drones of the target field, wherein the digital twin image is used to generate the drive path.

In some embodiments, the system projects field data along the drive path with setpoints for varying condition and generating a spatial map of reactor conditions, wherein the spatial map adjusts for conditions of the reactor based on projected reactor speed.

In step 840, a mobile pyrolysis system is deployed to follow the drive path. The mobile pyrolysis system includes one or more reactors with controllable parameters to adjust the pyrolysis operations of the one or more reactors.

In step 850, the deployed mobile pyrolysis system performs an in-field biochar production operation of the biomass in the target field by following the determined drive path about the target field area.

In some embodiments, the operation of the reactor of the deployed mobile pyrolysis system is adjusted based on the spatial map while the mobile pyrolysis system is maneuvered along the path.

In some embodiments, the multiple control parameters for operation of the reactor are determined based on field density and/or moisture data associated with the target field.

In some embodiments, while following the drive path, multiple control parameters of the reactor are changed to adjust for conditions of the biomass in the target field. Some of these control parameters: a reactor temperature, a system travel speed, a process residence time, an auger speed, and/or gas removal rates values.

In some embodiments, the generated path includes a series of geo-spatial waypoints (such as a GPS location or location coordinates). These series of waypoints form a track about the field for which the mobile pyrolysis system is to traverse to harvest the biomass. In some embodiments, the mobile pyrolysis system includes a display device with a screen to display a user interface upon which the path is displayed. An operator of the mobile pyrolysis system may maneuver the mobile pyrolysis system (such as a tractor) about the field according to the path.

The path includes control parameter changes that include values that are used by the system to automatically change operational values of the reactor of the mobile pyrolysis system. In some embodiments, the mobile pyrolysis system includes two separate reactors that are used to process biomass.

During the course of following the path, the different control parameter changes are applied to one or more reactors such that one or more reactors change their operation. For example, the rotational speed of an auger may be changed to increase or decrease the rate at which biomass is conveyed through one or more reactors. In another example, the temperature of one or more reactors may be increased or decreased. While following the path, the one or more reactor control parameters are continuously adjusted to produce biochar. The mobile pyrolysis system more efficiently produces the biochar since the mobile pyrolysis system is programmed to operate the one or more reactors using the initial analysis of the biomass material and locations of the biomass material as identified in the aerial imagery used by the system.

A controller or processor may read the values of the control parameter changes and apply the changes when the mobile pyrolysis system is at or about a particular waypoint (e.g., geo-spatial location).

### EXAMPLE EMBODIMENTS

The preferred embodiment of the invention is a system and process that combines real time remote satellite, aerial, and drone spectral imagery, and with NIR (Near Infrared), Multi- and Hyperspectral imaging to provide data on local soil and biomass including geographic location, temperature, relative humidity, and agricultural crop classifications, to identify waste to be used as feedstock for biomass processes and to accurately predict the optimal time of agricultural waste harvesting for specific crops and regions.

Another preferred embodiment of the invention is utilization of the system and process in conjunction with a mobile, edge-of-field or in-field system for pyrolysis of agricultural residues to produce biochar, bio-oil, or other upcycled products from agricultural wastes.

An embodiment of the present invention wherein the biomass process includes a process for in-field, on-the-fly pyrolytic conversion.

An embodiment of the present invention wherein the system tracks the deployment of biochar as a carbon removal medium and soil additive through space and time for accounting, performance monitoring, and reporting.

An embodiment of the present invention wherein imaging relies on multiple scales and resolutions including satellite imaging, aerial imaging, and ground based imaging.

An embodiment of the present invention wherein multispectral surface reflectance is used to determine quantities such as plant mass, plant moisture, plant stress, soil moisture, and vegetation classification.

Another embodiment pertains to the use of machine learning methods to tune pyrolysis reactor conditions based on data predicting the rate and quality of incoming biomass.

Another embodiment pertains to the use of a cloud-based computing system for data analysis in which both imaging data and processing of machinery data that is analyzed in a remote server.

Another embodiment pertains to the reduction of soil erosion through the controlled removal of plant residues based on measured soil conditions.

Another embodiment pertains to the measure of biomass which remains or will remain in the field post-harvest which can be utilized for pyrolytic conversion.

Another embodiment pertains to the measure of biomass prior to collection for pyrolysis conversion to biochar and post pyrolysis which can be utilized to determine percentage of biomass pyrolyzed and percentage of biomass remaining in the field for verification of sustainable crop residue removal rates.

### Additional Examples and Embodiments

While the field of smart agriculture is active and rapidly evolving, none of the applications have focused on management of crop waste or the production of a biochar soil amendment. The invention provides a means for tracking previously neglected field conditions in order to valorize agricultural residue materials previously considered wastes.

Variations in field and crop conditions including moisture content, biomass content, and biomass type, have significant impacts on the costs and energy associated with residue recovery and these are difficult to accurately track with conventional means. With regards to thermal processes specifically, small changes in moisture content, ash content, and biomass density can have significant impacts on process efficiency, yield, and fuel usage. The ability to collect high resolution field data through the use of satellite, aerial, and drone spectral imagery, and with multispectral imagery allows for the scheduling and route planning of harvesting and in-field processing equipment in a way that targets feedstocks at optimal times to reduce energy usage and increase product yields.

Pyrolysis systems and similar thermo-chemical processes require a specific balance of heat inputs to operate stability, and are sensitive to sudden changes in moisture, mass, and feedstock density. Another object of the invention is the utilization in conjunction with a mobile, edge-of-field or in-field system for pyrolysis of agricultural residues such that the control setpoints and heat inputs may be adjusted in advance of changes in biomass composition in order to provide more stable, efficient operation.

Another embodiment of the present invention is in tracking biomass collection and conversion into biochar as a carbon sequestration medium and soil additive. The same tools may be used to track the deployment of biochar to fields for reporting to customers and certification bodies. This is a significant improvement over conventional tracking, which relies on spot measurement of biomass and biochar properties, as well as tracking of masses with weight measurements on load cells. Spot checks allow for short term variations to be missed or over-represented, and load cell measurements are cumbersome and can be impacted by moisture and ash composition. Large scale, high resolution measurement with spectral data gives a clear recording of biomass measured and biochar applied with separate tracking of moisture and ash components.

An embodiment of the present invention is the use of imaging on multiple scales and resolutions with multiple spectra considered. This includes satellite imaging, aerial imaging, and ground based imaging, each of which present distinct advantages and disadvantages and which can be combined to give readings with a high degree of accuracy. Multispectral surface reflectance is used to determine quantities such as plant mass, plant moisture, plant stress, soil moisture, and vegetation classification.

Another embodiment of the present invention pertains to the use of machine learning methods to tune pyrolysis reactor conditions based on data predicting the rate and quality of incoming biomass. Conventional machine control processes utilize process data which is reactive to changes in process conditions. This can be difficult on high rate systems and pyrolysis systems which require a careful balance of energy in the system. The present invention allows for proactive control based on process setpoints and machine learning to anticipate changes to the system and adapt to them before system conditions can be impacted.

Another embodiment of the present invention pertains to the use of a cloud based computing system for data analysis in which both imaging data and process machinery data is analyzed in a remote server. This allows for cumulative processing of data by machine learning systems to inform the operation of a network of operational systems.

Another embodiment of the present invention which is advantageous over conventional practices pertains to reductions in soil erosion. Soil erosion is an issue in many climates, and one means of reducing erosion is to maintain crop residues in fields, limiting the availability of residues for carbon sequestration. Biochar addition has been shown to build soil quality, reducing erosion and the invention, as described herein, can be utilized to determine the optimal time and conditions for biochar conversion of in-field residues based on measured soil conditions in order to minimize soil erosion while sequestering carbon and building soil quality.

Another embodiment of the present invention is the focus on measurement and prediction of properties which are pertinent to biochar production including the mass and volume of biomass remaining in the field post harvest, the dryness of biomass residues, and similar pertinent properties.

Another embodiment of the present invention is the focus on measurement and prediction of soil properties which are pertinent to biochar integration including the soil moisture, soil organic carbon, and soil nutrient content.

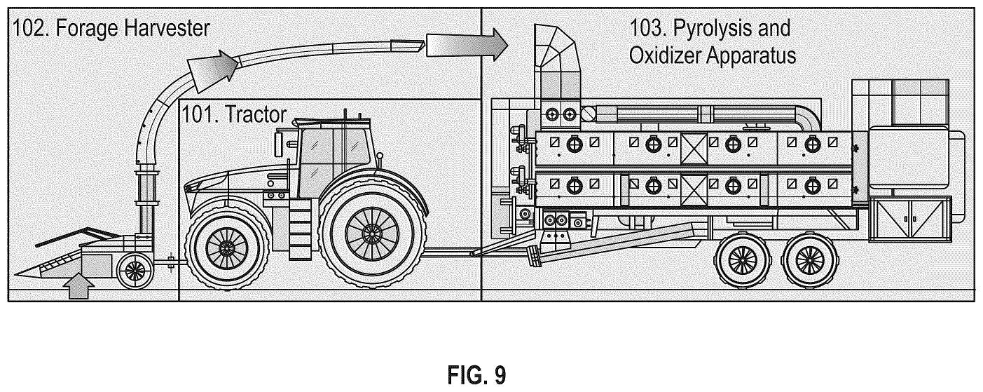

FIG. 9 is a diagram illustrating an embodiment of in-field biomass pyrolysis system for the production of biochar. In some embodiments, the system includes a forage harvester, tractor and pyrolysis and oxidizer apparatus. The system, as shown in FIG. 9 comprises three components: the Prime Mover (101) is a tractor which supplies locomotive power and control as well as hydraulic and mechanical power to other systems, the Forage Harvester (102) collects the in-field biomass and conveys it to the Pyrolysis Trailer (103) which converts harvested residues into biochar, quenches and deploys produced biochar, and cleanly combusts produced pyrolysis gases. The figure shown is one example of multiple potential embodiments in which the elements of power, harvesting, and conversion utilize three separate modules. This mobile pyrolysis system includes a reactor with controllable parameters to adjust the pyrolysis operation of the reactor.

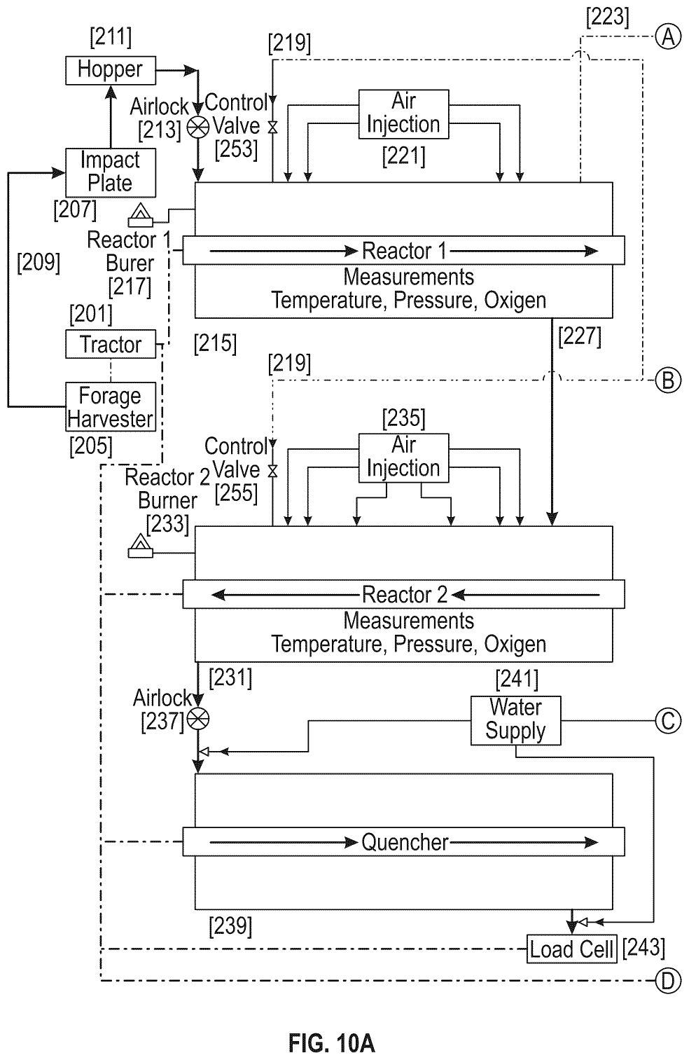

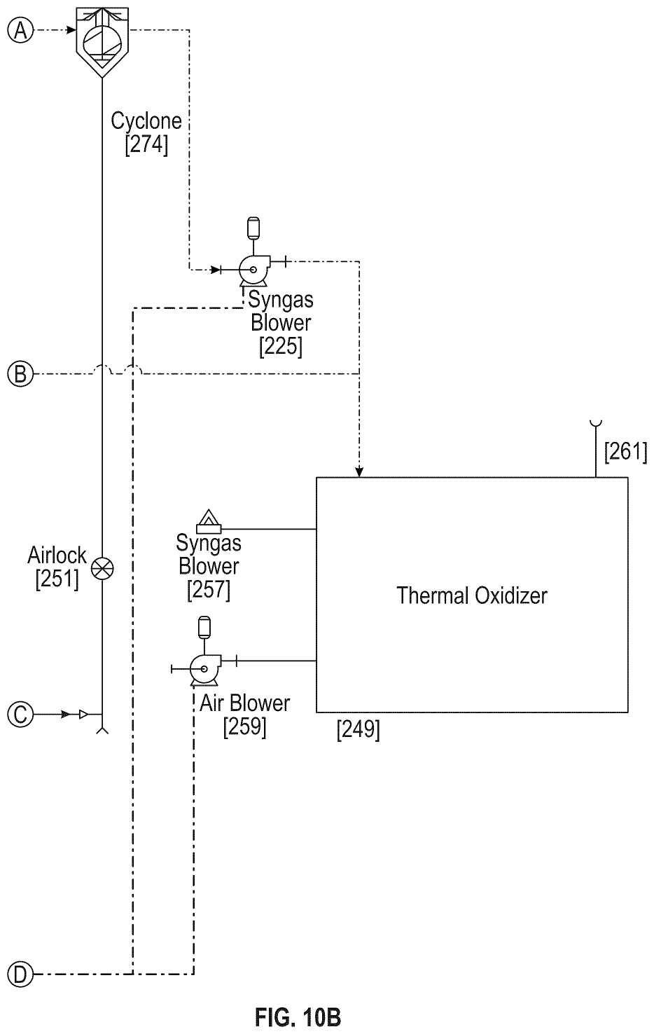

FIGS. 10A-10B are diagrams illustrating a process performed by the system according to some embodiments. The process works as follows: the system, shown in FIGS. 10A-10B, is moved through an agricultural field (such as corn field, rice field, sorghum field, or other row crop field), driven and powered by a Prime Mover (201) which supplies mechanical, hydraulic, and electrical power as well as control. Biomass residues (203) are collected by the Forage Harvester (205) which chops and sizes incoming biomass to a target size. Sized biomass is conveyed pneumatically through a Capacitive Flowmeter (207) to an Impact Plate Flowmeter (209) before collection in the Input Hopper (211). Measurements from the Capacitive Flowmeter (207) and Impact Plate Flowmeter (209) are compared to provide information on incoming feedstock moisture content and other properties.

Feedstock from the Input Hopper (211) is conveyed through the Input Airlock (213) into Reactor 1 (215). Reactor 1 is heated through a combination of the Reactor 1 Burner (217), recirculated pyrolysis gases (219), and Air Injection (221) which react with produced and recycled pyrolysis gases in a partial oxidation reaction. In practice, a burner may be used to externally oxidize recycled pyrolysis gases, outside of reactor 1. Biomass and gases move through Reactor 1 (215) in a co-current configuration. As the biomass moves through Reactor 1 (215), via two auger screws the biomass material experiences a torrefaction process at reactor temperatures between 200-400° C., reaching temperatures between 100-400° C. Pyrolysis gases, or Reactor 1 Syngas (223), produced in Reactor 1 (215) are removed via suction from the Syngas Blower (225) and mixed with Reactor 2 Syngas (227). Torrefied material is gravity fed into Reactor 2 (231).

Reactor 2 (231) is heated through a combination of the Reactor 2 Burner (233), recirculated pyrolysis gases (219), and Air Injection (235) which reacts with produced pyrolysis gases in a partial oxidation reaction. Torrefied biomass and gases move through Reactor 1 (215) in a counter-current configuration. As the torrefied biomass moves though Reactor 2 (215), via two auger screws the biomass material is pyrolyzed at reactor temperatures between 500-800° C., reaching material temperatures between 400-600° C. Pyrolyzed biochar exits Reactor 2 (231) through the Outlet Airlock (237) into the Quencher (239) where it is cooled with Water (241) before weight measurement at an outlet Load Cell (243) and discharge to a Spreader (245). Reactor 2 Syngas (227), produced in Reactor 2 (231) is removed via suction from the Syngas Blower (225) and mixed with Reactor 1 Syngas (223) to form a Combined Syngas Stream (229).

The Combined Syngas Stream (229) is motivated to a Cyclone (247), where larger particles are removed and then to a Thermal Oxidizer (249) to cleanly combust all pyrolysis products. Entrained char from the syngas is removed by the Cyclone (247) through the Cyclone Airlock (251) and quenched with water (241) before being disposed to the ground directly or through a spreader or mixer.

The Thermal Oxidizer (249) combusts pyrolysis gases in the Combined Syngas Stream (229) using air from the Air Blower (251) and ignition from the Thermal Oxidizer Burner (257). The Thermal Oxidizer Burner may be any burner capable of initiating combustion in the Thermal Oxidizer (249), but practically a multi-fuel, modulating burner is the ideal choice.

The control methodology, which is key to the operation of the invention, consists of a series of feedback loops and predictive control algorithms which control reaction conditions based on sensor data and prior run data. The system described herein is thermally self-sustaining, utilizing the chemical energy from oxidation of pyrolysis gases to drive the process through partial oxidation. In order to start the system, external energy is required, creating a need for multiple, distinct control conditions. Separating process stages into multiple distinct conditions allows for fine tuning of control based on the specific thermochemical reactions occurring at each stage. At minimum, four control stages are described, although the process may be divided into eight or more distinct control stages. The minimum four stages are Preheat, Transition, Autothermal, and Shutdown.

Preheat operation describes a condition where a cold system is brought up to reaction temperatures. This is accomplished using external energy from external fuels such as propane, diesel, biodiesel, charcoal, natural gas, electric heating, or others. Biomass feedstock will be fed at a low rate. The goal of this stage is to heat the reactor to temperatures which will initiate thermal decomposition of the feedstock, priority is not on product char quality or yield. This stage continues until the system reaches target temperatures.

Transition operation describes a condition where the system transitions off of external fuels in order to operate in a thermally self-sustaining modality. A secondary goal is to reduce the total air added to the process. Added air supplies energy through oxidation of process gases but should be minimized to preserve solid carbon yields. The transition is described as a gradual shift, where external fuels are first modulated down so that all of the process energy is derived from incoming biomass feedstock and then where air into the system is balanced to maintain efficiency.

Autothermal operation describes the standard operating condition of the system, where the goal is to maintain reactor conditions as biomass is pyrolyzed. The goal of the control system in this stage is to maintain balanced control and adjust for variations in conditions from input variations. This stage can be enhanced by using predictive control algorithms to proactively adjust reactor heating rates based on measured variations in input feed rate, moisture, and composition.

Shutdown operation describes the process of safely evacuating biomass, char, and gases from the reactors and cooling the combustible gas concentration and temperature in the reactor to a safe level. system in a manner which is safe for both operators and equipment.

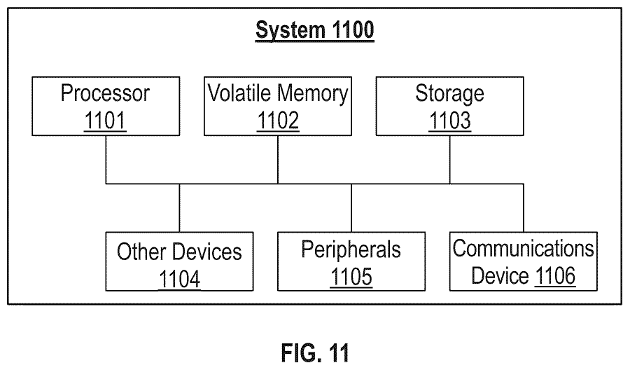

FIG. 11 is a diagram illustrating an exemplary computer that may perform processing in some embodiments. Exemplary computer 1100 may perform operations consistent with some embodiments of the processes as described herein. The architecture of computer 1100 is exemplary. Computers can be implemented in a variety of other ways. A wide variety of computers can be used in accordance with the embodiments herein.

Processor 1101 may perform computing functions such as running computer programs. The volatile memory 1102 may provide temporary storage of data for the processor 1101. RAM is one kind of volatile memory. Volatile memory typically requires power to maintain its stored information. Storage 1103 provides computer storage for data, instructions, and/or arbitrary information. Non-volatile memory, which can preserve data even when not powered and including disks and flash memory, is an example of storage. Storage 1103 may be organized as a file system, database, or in other ways. Data, instructions, and information may be loaded from storage 1103 into volatile memory 1102 for processing by the processor 1101.

The computer 1100 may include peripherals 1105. Peripherals 1105 may include input peripherals such as a keyboard, mouse, trackball, video camera, microphone, and other input devices. Peripherals 1105 may also include output devices such as a display. Peripherals 1105 may include removable media devices such as CD-R and DVD-R recorders/players. Communications device 1106 may connect the computer 1000 to an external medium. For example, communications device 1106 may take the form of a network adapter that provides communications to a network. A computer 1100 may also include a variety of other devices 1104. The various components of the computer 1100 may be connected by a connection medium 1110 such as a bus, crossbar, or network.

It will be appreciated that the present disclosure may include any one and up to all of the following examples.

Example 1. A method in-field production of biochar, comprising the operations: performing a field mapping of a target field having a biomass and obtaining spectral imagery data of the biomass; using the spectral imagery data of the biomass to identify biomass feedstock to generate a vegetation index; determining a drive path based on the vegetation index, wherein the drive path comprises a series of geo-spatial locations; and deploying a mobile pyrolysis system, the mobile pyrolysis system comprising a reactor with controllable parameters to adjust the pyrolysis operation of the reactor; and performing by the deployed mobile pyrolysis system an in-field biochar production operation of the biomass by following the determined drive path about the target field area.

Example 2. The method of Example 1, wherein the spectral imagery data is captured from satellite sensors, aerial sensors, and agricultural drones that obtain sensor data of the target field area.

Example 3. The method of any one of Examples 1-2, further comprising the operations of: collecting one more of data comprising spectral imagery data, measured soil data, historical operational data, and weather and satellite data; and geospatially aligning data points of collected data to correspond to geo-spatial locations of where yield data of the biomass was collected about the target field.

Example 4. The method of any one of Examples 1-3, further comprising the operations of: projecting field data along the drive path with setpoints for varying condition and generating a spatial map of reactor conditions, wherein the spatial map adjusts for conditions of the reactor based on projected reactor speed; and operating the reactor of the deployed mobile pyrolysis system and adjusting reactor conditions based on the spatial map while the mobile pyrolysis system is maneuvered along the path.

Example 5. The method of any one of Examples 1-4, further comprising the operations of: converting a multispectral image data set of images obtained by one or more drones into the vegetation index, wherein the vegetation index identifies crop health data, field density data and/or moisture content data of the target field.

Example 6. The method of any one of Examples 1-5, wherein the multiple control parameters for the reactor are determined based on field density and/or moisture data associated with the target field.

Example 7. The method of any one of Examples 1-6, further comprising the operations of: while following the drive path, changing multiple control parameters of the reactor including one or more control parameters comprising one or more of: a reactor temperature, a system travel speed, a process residence time, and/or gas removal rates values.

Example 8. The method of any one of Examples 1-7, further comprising the operations of: generating a stitched digital twin image or mapping of the target field based on multiple images obtained by one or more drones of the target field, wherein the digital twin image is used to generate the drive path.

Example 9. The method of any one of Examples 1-8, further comprising the operations of: determining multiple moisture content values of biomass in different areas of the target field; based on the determined multiple moisture content values, generating a plurality of control parameters to increase or decrease a temperature of the reactor; associating each of the control parameters with a geospatial location associated with a position of the area where a moisture content value of the biomass was determined; and applying the respective control parameters to the reactor to change the temperature of the reactor while the mobile pyrolysis system is traveling along the drive path.

Example 10. The method of any one of Examples 1-9, further comprising the operations of: determining a first type of biomass and a second type of biomass in the target field, wherein the first type biomass is a different type of plant than the second type biomass; determining geospatial locations for the drive path where a first set of geospatial locations are associated with the first type of biomass, and a second set of geospatial locations are associated with the second type of biomass; based on the determined first type of biomass, generating a first plurality of control parameter to process the first type of biomass by the reactor; based on the determined second type of biomass, generating a second plurality of control parameters to process the second type of biomass by the reactor; applying the first plurality of control parameter to the reactor while the mobile pyrolysis system is traveling along the drive path for the first set of geospatial locations; and applying the second plurality of control parameter to the reactor while the mobile pyrolysis system is traveling along the drive path for the second set of geospatial locations.

Example 11. An in-field biomass pyrolysis system for the production of biochar, comprising: a system comprising one or more processors configured to perform the operation of: performing a field mapping of a target field having a biomass and obtaining spectral imagery data of the biomass; using the spectral imagery data of the biomass to identify biomass feedstock to generate a vegetation index; and determining a drive path based on the vegetation index, wherein the drive path comprises a series of geo-spatial locations; and a mobile pyrolysis system comprising a reactor with controllable parameters to adjust the pyrolysis operation of the reactor, wherein the mobile pyrolysis system is configured to perform the operation of: performing an in-field biochar production operation of the biomass by following the determined drive path about the target field area.

Example 12. The system of Example 11, wherein the spectral imagery data is captured from satellite sensors, aerial sensors, and agricultural drones that obtain sensor data of the target field area.

Example 13. The system of any one of Example 11-12, wherein the one or more processors are further configured to perform the operations of: collecting one more of data comprising spectral imagery data, measured soil data, historical operational data, and weather and satellite data; and geospatially aligning data points of collected data to correspond to geo-spatial locations of where yield data of the biomass was collected about the target field.

Example 14. The system of any one of Example 11-13, wherein the one or more processors are further configured to perform the operations of: projecting field data along the drive path with setpoints for varying condition and generating a spatial map of reactor conditions, wherein the spatial map adjusts for conditions of the reactor based on projected reactor speed; and operating the reactor of the deployed mobile pyrolysis system and adjusting reactor conditions based on the spatial map while the mobile pyrolysis system is maneuvered along the path.

Example 15. The system of any one of Example 11-14, wherein the one or more processors are further configured to perform the operations of: converting a multispectral image data set of images obtained by one or more drones into the vegetation index, wherein the vegetation index identifies crop health data, field density data and/or moisture content data of the target field.

Example 16. The system of any one of Example 11-15, wherein the multiple control parameters for the reactor are determined based on field density and/or moisture data associated with the target field.

Example 17. The system of any one of Example 11-16, wherein the mobile pyrolysis system is further configured to: while following the drive path, changing multiple control parameters of the reactor including one or more control parameters comprising one or more of: a reactor temperature, a system travel speed, a process residence time, an auger speed, and/or gas removal rates values.

Example 18. The system of any one of Example 11-17, wherein the one or more processors are further configured to perform the operations of: generating a stitched digital twin image or mapping of the target field based on multiple images obtained by one or more drones of the target field, wherein the digital twin image is used to generate the drive path.

Example 19. The system of any one of Example 11-18, wherein the one or more processors are further configured to perform the operations of: determining multiple moisture content values of biomass in different areas of the target field; based on the determined multiple moisture content values, generating a plurality of control parameters to increase or decrease a temperature of the reactor; associating each of the control parameters with a geospatial location associated with a position of the area where a moisture content value of the biomass was determined; and applying the respective control parameters to the reactor to change the temperature of the reactor while the mobile pyrolysis system is traveling along the drive path.

Example 20. The system of any one of Example 11-19, wherein the one or more processors are further configured to perform the operations of: determining a first type of biomass and a second type of biomass in the target field, wherein the first type biomass is a different type of plant than the second type biomass; determining geospatial locations for the drive path where a first set of geospatial locations are associated with the first type of biomass, and a second set of geospatial locations are associated with the second type of biomass; based on the determined first type of biomass, generating a first plurality of control parameter to process the first type of biomass by the reactor; based on the determined second type of biomass, generating a second plurality of control parameters to process the second type of biomass by the reactor; applying the first plurality of control parameter to the reactor while the mobile pyrolysis system is traveling along the drive path for the first set of geospatial locations; and applying the second plurality of control parameter to the reactor while the mobile pyrolysis system is traveling along the drive path for the second set of geospatial locations.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

Some portions of the preceding detailed descriptions have been presented in terms of processes and symbolic representations of operations on data bits within a computer memory. These process descriptions and representations are the ways used by those skilled in the data processing arts to most effectively convey the substance of their work to others skilled in the art. An processes is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

What is claimed is:

1. A method in-field production of biochar, comprising the operations:
performing a field mapping of a target field having a biomass and obtaining spectral imagery data of the biomass;
using the spectral imagery data of the biomass to identify biomass feedstock to generate a vegetation index;
determining a drive path based on the vegetation index, wherein the drive path comprises a series of geo-spatial locations; and
deploying a mobile pyrolysis system, the mobile pyrolysis system comprising a reactor with controllable parameters to adjust the pyrolysis operation of the reactor; and
performing by the deployed mobile pyrolysis system an in-field biochar production operation of the biomass by following the determined drive path about the target field area.

2. The method of claim 1, wherein the spectral imagery data is captured from satellite sensors, aerial sensors, and agricultural drones that obtain sensor data of the target field area.

3. The method of claim 1, further comprising the operations of:
collecting one more of data comprising spectral imagery data, measured soil data, historical operational data, and weather and satellite data; and
geospatially aligning data points of collected data to correspond to geo-spatial locations of where yield data of the biomass was collected about the target field.

4. The method of claim 1, further comprising the operations of:
projecting field data along the drive path with setpoints for varying condition and generating a spatial map of reactor conditions, wherein the spatial map adjusts for conditions of the reactor based on projected reactor speed; and
operating the reactor of the deployed mobile pyrolysis system and adjusting reactor conditions based on the spatial map while the mobile pyrolysis system is maneuvered along the path.

5. The method of claim 1, further comprising the operations of:
converting a multispectral image data set of images obtained by one or more drones into the vegetation index, wherein the vegetation index identifies crop health data, field density data and/or moisture content data of the target field.

6. The method of claim 5, wherein the multiple control parameters for the reactor are determined based on field density and/or moisture data associated with the target field.

7. The method of claim 6, further comprising the operations of:
while following the drive path, changing multiple control parameters of the reactor including one or more control parameters comprising one or more of: a reactor temperature, a system travel speed, a process residence time, and/or gas removal rates values.

8. The method of claim 1, further comprising the operations of:
generating a stitched digital twin image or mapping of the target field based on multiple images obtained by one or more drones of the target field, wherein the digital twin image is used to generate the drive path.

9. The method of claim 1, further comprising the operations of:
determining multiple moisture content values of biomass in different areas of the target field;
based on the determined multiple moisture content values, generating a plurality of control parameters to increase or decrease a temperature of the reactor;
associating each of the control parameters with a geospatial location associated with a position of the area where a moisture content value of the biomass was determined; and
applying the respective control parameters to the reactor to change the temperature of the reactor while the mobile pyrolysis system is traveling along the drive path.

10. The method of claim 1, further comprising the operations of:
determining a first type of biomass and a second type of biomass in the target field, wherein the first type biomass is a different type of plant than the second type biomass;
determining geospatial locations for the drive path where a first set of geospatial locations are associated with the first type of biomass, and a second set of geospatial locations are associated with the second type of biomass;
based on the determined first type of biomass, generating a first plurality of control parameter to process the first type of biomass by the reactor;
based on the determined second type of biomass, generating a second plurality of control parameters to process the second type of biomass by the reactor;
applying the first plurality of control parameter to the reactor while the mobile pyrolysis system is traveling along the drive path for the first set of geospatial locations; and
applying the second plurality of control parameter to the reactor while the mobile pyrolysis system is traveling along the drive path for the second set of geospatial locations.

11. An in-field biomass pyrolysis system for the production of biochar, comprising:
a system comprising one or more processors configured to perform the operation of:
performing a field mapping of a target field having a biomass and obtaining spectral imagery data of the biomass;
using the spectral imagery data of the biomass to identify biomass feedstock to generate a vegetation index; and
determining a drive path based on the vegetation index, wherein the drive path comprises a series of geo-spatial locations; and
a mobile pyrolysis system comprising a reactor with controllable parameters to adjust the pyrolysis operation of the reactor, wherein the mobile pyrolysis system is configured to perform the operation of:
performing an in-field biochar production operation of the biomass by following the determined drive path about the target field area.

12. The system of claim 11, wherein the spectral imagery data is captured from satellite sensors, aerial sensors, and agricultural drones that obtain sensor data of the target field area.

13. The system of claim 11, wherein the one or more processors are further configured to perform the operations of:
collecting one more of data comprising spectral imagery data, measured soil data, historical operational data, and weather and satellite data; and
geospatially aligning data points of collected data to correspond to geo-spatial locations of where yield data of the biomass was collected about the target field.

14. The system of claim 11, wherein the one or more processors are further configured to perform the operations of:
projecting field data along the drive path with setpoints for varying condition and generating a spatial map of reactor conditions, wherein the spatial map adjusts for conditions of the reactor based on projected reactor speed; and
operating the reactor of the deployed mobile pyrolysis system and adjusting reactor conditions based on the spatial map while the mobile pyrolysis system is maneuvered along the path.

15. The system of claim 11, wherein the one or more processors are further configured to perform the operations of:
converting a multispectral image data set of images obtained by one or more drones into the vegetation index, wherein the vegetation index identifies crop health data, field density data and/or moisture content data of the target field.

16. The system of claim 15, wherein the multiple control parameters for the reactor are determined based on field density and/or moisture data associated with the target field.

17. The system of claim 16, wherein the mobile pyrolysis system is further configured to:
while following the drive path, changing multiple control parameters of the reactor including one or more control parameters comprising one or more of: a reactor temperature, a system travel speed, a process residence time, an auger speed, and/or gas removal rates values.

18. The system of claim 11, wherein the one or more processors are further configured to perform the operations of:
generating a stitched digital twin image or mapping of the target field based on multiple images obtained by one or more drones of the target field, wherein the digital twin image is used to generate the drive path.

19. The system of claim 11, wherein the one or more processors are further configured to perform the operations of:
determining multiple moisture content values of biomass in different areas of the target field;
based on the determined multiple moisture content values, generating a plurality of control parameters to increase or decrease a temperature of the reactor;
associating each of the control parameters with a geospatial location associated with a position of the area where a moisture content value of the biomass was determined; and
applying the respective control parameters to the reactor to change the temperature of the reactor while the mobile pyrolysis system is traveling along the drive path.

20. The system of claim 11, wherein the one or more processors are further configured to perform the operations of:
determining a first type of biomass and a second type of biomass in the target field, wherein the first type biomass is a different type of plant than the second type biomass;
determining geospatial locations for the drive path where a first set of geospatial locations are associated with the first type of biomass, and a second set of geospatial locations are associated with the second type of biomass;
based on the determined first type of biomass, generating a first plurality of control parameter to process the first type of biomass by the reactor;
based on the determined second type of biomass, generating a second plurality of control parameters to process the second type of biomass by the reactor;
applying the first plurality of control parameter to the reactor while the mobile pyrolysis system is traveling along the drive path for the first set of geospatial locations; and
applying the second plurality of control parameter to the reactor while the mobile pyrolysis system is traveling along the drive path for the second set of geospatial locations.
